(19) United States
(12) Patent Application Publication
(10) Pub. No.: US 2010/0095342 A1
(43) Pub. Date: Apr. 15, 2010

(54) WIRELESS CONTENT TRANSMISSION AND CONTROL

(75) Inventors: Hanoz Gandhi, Marina Del Rey, CA (US); Amala Kelshiker, Chandler, AZ (US); Kristina Donofrio, Simi Valley, CA (US); Jimmy K. Lau, Temple City, CA (US); Ronald C. Moffatt, Rochester, NY (US); Joel Chlodnik, Irvine, CA (US)

Correspondence Address: BRYAN CAVE LLP, TWO NORTH CENTRAL AVENUE, SUITE 2200, PHOENIX, AZ, 85004, US

(73) Assignee: Belkin International, Inc., Compton, CA (US)

(21) Appl. No.: 12/537,244

(22) Filed: Aug. 6, 2009

Related U.S. Application Data
(60) Provisional application No. 61/086,708, filed on Aug. 6, 2008.

(51) Int. Cl. H04N 7/173

(52) U.S. Cl. 725/117

(57) ABSTRACT

A wireless transmission system is provided. The wireless transmission system can include: (a) a receiver unit capable of being coupled to a display device; and (b) a transmitter unit that sends a wireless signal to the receiver unit, wherein the wireless signal comprises a bandwidth sufficient enough to carry high definition video content. Other embodiments are disclosed.

### CROSS-REFERENCE TO RELATED APPLICATIONS

This application claims the benefit of U.S. Provisional Application No. 61/086,708, filed Aug. 6, 2008 and entitled Wireless Content Transmission and Control, which is incorporated herein by reference.

### FIELD OF INVENTION

This disclosure relates to wireless transmission and control of audio/video content.

### DESCRIPTION OF THE RELATED ART

The ready availability and ever-decreasing prices of flat panel televisions and monitors has made it possible to place a video or computer display in nontraditional locations such as on a wall above another item of furniture or over a fireplace. In such locations, the video display is usually remote from the DVD player, Blu-ray® player, cable box, or other audio/video content source, and a cable or cables are typically required to route the audio/video signal from the content source to the viewing device. Particularly in the case of a high definition video display having an HDMI (High Definition Multimedia Interface) input port, the required multi-conductor cable can be bulky and obtrusive. Thus the possible locations for a video display can be limited by the need to route a video cable or cables from the content source.

### DESCRIPTION OF THE DRAWINGS

The invention will be better understood from a reading of the following detailed description of examples of embodiments, taken in conjunction with the accompanying figures in the drawings in which:

FIG. 1 is a block diagram of a system for wireless transmission and control of audio/video content.

FIG. 2 is a block diagram of a receiver unit.

FIG. 3 is a block diagram of a transmitter unit.

FIG. 4 is a block diagram of a system for wireless transmission and control of audio/video content.

FIG. 5 is a block diagram of a system for wireless transmission and control of audio/video content.

FIG. 6 is a flow chart for a process to control a system for wireless transmission of audio/video content.

FIG. 7 is a flow chart for a process to provide EDID information to an HDMI audio/video content source.

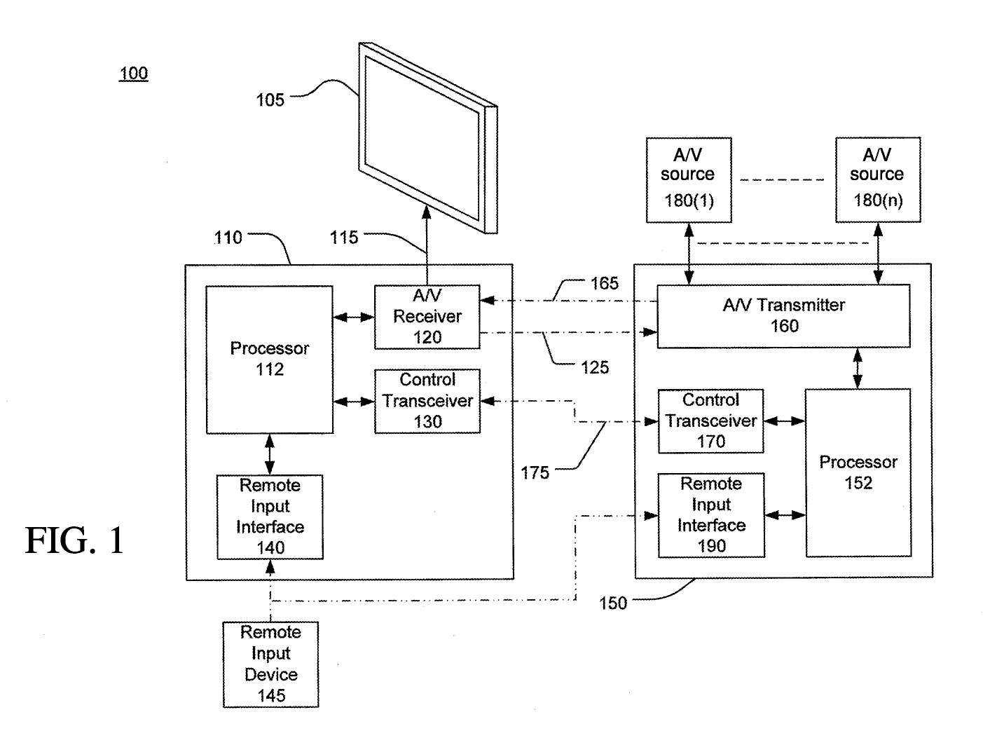

Throughout this description, elements appearing in the block diagrams of FIG. 1-FIG. 5 are assigned three-digit reference designators, where the most significant digit is the figure number and the two least significant digits are specific to the element. An element that is not described in conjunction with a block diagram may be presumed to have the same characteristics and function as a previously-described element having a reference designator with the same two least significant digits.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically or otherwise. Two or more electrical elements may be electrically coupled, but not mechanically or otherwise coupled; two or more mechanical elements may be mechanically coupled, but not electrically or otherwise coupled; two or more electrical elements may be mechanically coupled, but not electrically or otherwise coupled. Coupling (whether mechanical, electrical, or otherwise) may be for any length of time, e.g., permanent or semi permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types. The absence of the word “removably,” “removable,” and the like near the word “coupled,” and the like does not mean that the coupling, etc. in question is or is not removable.

### DETAILED DESCRIPTION

In one embodiment, a wireless transmission system is provided. The wireless transmission system can include: (a) a receiver unit capable of being coupled to a display device; and (b) a transmitter unit that sends a wireless signal to the receiver unit, wherein the wireless signal comprises a bandwidth sufficient enough to carry high definition video content.

In another embodiment, a wireless transmission system is provided. The wireless transmission system can include: (a) a transmitting portion receiving a first audio/video signal from one or more audio/video sources; and (b) a receiving portion receiving a second audio/video signal from the transmitting portion and sending a third audio/video signal to a display device; wherein the second audio/video signal is wireless, and the first audio/video signal, the second audio/video signal, and the third audio/video signal comprise high definition video content.

In yet another embodiment, a process of exchanging data is provided. The process can include: (a) detecting the presence of one or more audio/video sources that are coupled to a transmitter unit; (b) indicating the presence of the transmitter unit to the one or more audio/video sources; (c) indicating the presence of a receiver unit to a display device; (d) detecting a signal from the display device by the receiver unit; (e) retrieving enhanced display identification data from the device; (f) transmitting the enhanced display identification data from the receiver unit to the transmitter unit; and (g) providing the enhanced display identification data from the transmitter unit to the one or more audio/video sources.

Referring now to FIG. 1, a system 100 for wireless transmission and control of audio/video content may include a receiver unit 110 and a transmitter unit 150. The receiver unit 110 may include an audio/video (A/V) receiver 120 that receives a wireless A/V signal 165 carrying audio/video content from an A/V transmitter 160 within the transmitter unit 150. The A/V receiver 120 may convert the received A/V content to provide an output 115 to a display device 105. The output 115 may be compatible with the High Definition Multimedia Interface (HDMI) standard, which includes both video and audio signals. The output 115 may be compatible with some other standard, and may include multiple video and audio outputs.

The receiver unit 110 may include a first control transceiver 130 for bidirectional communication of command and control information with the transmitter unit 150 via a wireless command channel 175. The receiver unit 110 may also include or be coupled to a first remote input interface 140 to receive input data from a remote input device 145. For example, the first remote input interface 140 may be an infrared (IR) receiver and the remote input device 145 may be a conventional IR remote control device. The first remote input interface 140 may be another interface for another wired or wireless remote input device.

The receiver unit 110 may include a processor 112 to supervise and coordinate the operation of the A/V receiver 120, the first control transceiver 130, and the first remote input interface 140.

The transmitter unit 150 may include an A/V transmitter 160 that receives audio/video content from one or more A/V content sources 180(1)-180(n) and transmits the audio/video content as the wireless A/V signal 165. As an example, A/V content sources can include, DVD players, Blu-ray® players, HD-DVD players, receivers, video-game consoles, and set-top boxes. The wireless A/V signal 165 may be a microwave signal having sufficient bandwidth to carry high definition video content. The wireless A/V signal 165 may have a carrier frequency of 5 GHz or some other microwave frequency. The audio/video content may be encoded and modulated onto the wireless A/V signal 165 in any manner that supports the required bandwidth. The audio/video content may be encoded and modulated onto the wireless A/V signal 165 in a manner that does not compress or otherwise degrade the audio/video content. The audio/video content may be encrypted for transmission over the wireless A/V signal 165. The encryption key used to encrypt the audio/video content for transmission over the wireless A/V signal 165 may be unique to the transmitter unit 150 and the receiver unit 110. The encryption key may be negotiated between the transmitter unit 150 and the receiver unit.

The transmitter unit 150 may also include a second control transceiver 170 for bidirectional communication of command and control information with the receiver unit 110 via the command channel 175. The command channel 175 may have the same frequency or a different frequency, and the same modulation method or a different modulation method, as the wireless A/V signal 165.

The transmitter unit 150 may receive video transmission control data from the receiver unit 110 via a wireless backchannel signal 125. The wireless backchannel signal 125 may have the same frequency or a different frequency, and the same modulation method or a different modulation method, as the wireless A/V signal 165 and/or command channel 175. The wireless A/V signal 165 may also be capable of carrying video transmission control data interleaved between or within video frames. The video transmission control data communicated via the wireless backchannel signal 125 and the wireless A/V signal 165 may include Enhanced Display Identification Data (EDID) from the display device 105 and parameters, such as status data indicating that the receiver unit 110 has exchanged High Definition Content protection (HDCP) key selection vectors and established an encrypted communication path with the display device 105, necessary to enable the transmitter unit 150 to send A/V content to the receiver unit 110. The video transmission control data may also be communicated, at least in part, between the transmitter unit 150 and the receiver unit 110 over the command channel 175. The wireless backchannel 125, if used, may be independent of the command channel 175.

The control information communicated between the first and second control transceivers 130/170 via the command channel 175 may include handshake information required to establish wireless transmission of audio/video content from the transmitter unit 150 to the receiver unit 110. The control information communicated between the first and second control transceivers 130/170 may include input data entered using the remote input device 145 and transmitted from the first control transceiver 130 to the second control transceiver 170. The input data entered using the remote input device 145 may include commands that control, at least in part, the operation of the transmitter unit 150. The input data entered using the remote input device 145 may also include commands that control, at least in part, the operation of at least some of the A/V content sources 180(1)-180(n).

The transmitter unit 150 may also include or be coupled to a second remote input interface 190 to receive input data from the remote input device 145. For example, the remote input interface 190 may be an infrared (IR) receiver and the remote input device 145 may be a conventional IR remote control device. The remote input interface 190 may be another interface for a wired or wireless remote input device.

The transmitter unit 150 may include a processor 152 and software/firmware to supervise and coordinate the operation of the A/V transmitter 160, the second control transceiver 170, and the second remote input interface 190.

In the example of FIG. 1, the transmitter unit 150 can be controllable, at least in part, by input data received from the remote input device 145. The transmitter unit 150 can be adapted to select audio/video content from a plurality of audio/video content sources 180(1)-180(n), and the transmitter unit can select audio/video content from one of the plurality of audio/video content sources 180(1)-180(n) based on input data received from the remote input device 145. The transmitter unit 150 can be adapted to relay input data received from the remote input device 145 to at least one of the plurality of audio/video content sources 180(1)-180(n). The transmitter unit 150 can be adapted to relay input data received from the remote input device 145 to the plurality of audio/video content sources 180(1)-180(n) using an infrared blaster. In some examples, the transmitter unit 150 can be adapted to receive audio/video content through a plurality of possible interfaces, such as, for example, HDMI, DVI (Digital Visual Interface), SCART (Syndicat des Constructeurs d'Appareils Radiorécepteurs et Téléviseurs), composite video, S-video, component video, component audio, TOSLINK (Toshiba-Link) (a standardized optical fiber connection system), and ADAT Lightpipe (a standard for the transfer of digital audio between equipment).

In addition, the receiver unit 110 can send video transmission control information to the transmitter unit 150 via a backchannel 125 independent of the command channel 175, and the transmitter unit 150 can send video transmission control information to the video receiver embedded within the audio/video content. The video transmission control information can include Enhanced Display Identification Data (EDID).

Furthermore, the receiver unit 110 can comprise a High Definition Media Interface (HDMI) connection for the display device 105, and the transmitter unit 150 can comprise an internal EDID memory, and the transmitter unit 150 can provide at least one content source with EDID information from the internal EDID memory when EDID information from a display device connected to the receiver unit is not available, and the transmitter unit can provide at least one content source with EDID information from the display device when EDID information from the display device is available.

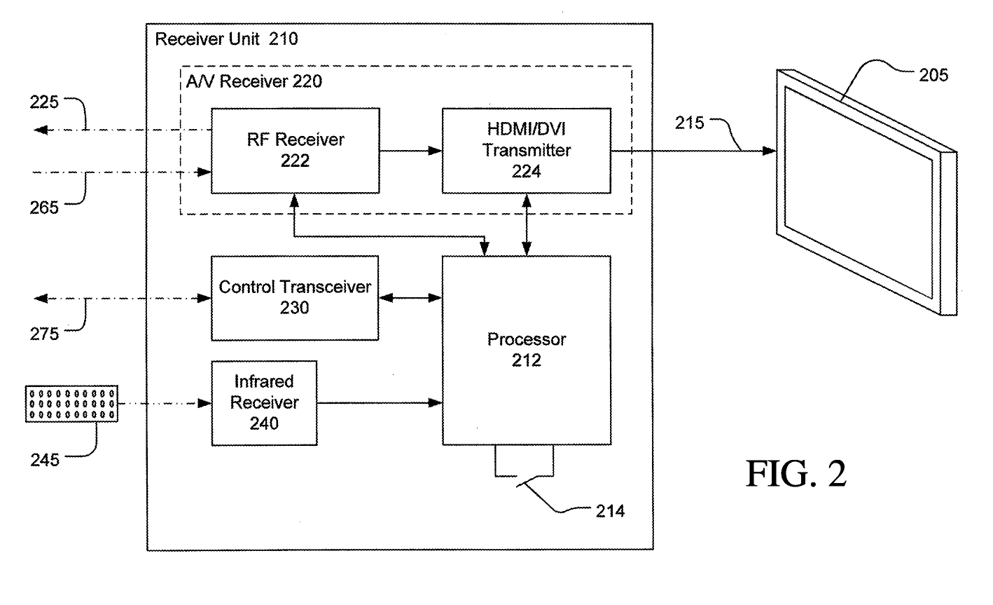

FIG. 2 is a block diagram of a receiver unit 210, which may be the receiver unit 110 of FIG. 1. The receiver unit 210 may include an A/V receiver 220, a first control transceiver 230, and a processor 212. A remote input interface 240, in the form of an IR receiver or other interface, may be included in or coupled to the receiver unit 210. The A/V receiver 220 may include an RF receiver 222 and an HDMI transmitter to receive a wireless A/V signal 265 and to convert the wireless A/V signal 265 into an HDMI output signal 215. In addition, the receiver unit 210 may send video transmission control data to a transmitter unit via a wireless backchannel signal 225.

The A/V receiver 220 may decrypt the received wireless A/V signal 265 using an encryption key and method defined for communication between the receiver unit 210 and a mating transmitter unit. The A/V receiver 220 may then re-encrypt the HDMI output signal 215 using the HDCP protocol and an encryption key negotiated with a display device 205.

The remote input interface 240 may be an IR receiver to receive input data from a remote input device 245. In this description, the term “input data” is intended to encompass commands, control sequences, alphanumeric text, and any other input data enterable using the remote input device 245. The remote input interface 240 may be a separate physical unit, commonly termed a “dongle”, coupled to the receiver unit 210 through a short cable that allows the remote input interface unit to be conveniently positioned. The remote input interface dongle may be decoupled from the receiver unit 210 if not required in a specific installation. In other examples, the remote input interface 240 can be integral with the receiver unit 210.

The processor 212 may supervise and coordinate the operation of the A/V receiver 220, the control transceiver 230, and the remote input interface 240. The processor 212 may perform processing operations including, but not limited to, translating data formats between the other elements of the receiver unit and performing calculations that may be required to exchange key selection vectors and establish an encrypted communication path with the display device 205 according to the HDCP protocol. The processor 212 may be coupled to a mate switch 214 that causes the processor 212 to initiate a mating application to negotiate and establish parameters required for the receiver unit 210 to exclusively communicate with a designated transmitter unit (not shown in FIG. 2), such as for example, transmitter unit 150 (FIG. 1). The parameters may include one or more frequencies, data rates, encryption keys, configuration parameters, and other parameters required to “mate” the receiver unit 210 to a unique transmitter unit. In some examples, the processor 212 can coordinate communication between the control transceiver 230 and a control transceiver of a transmitter unit via a command channel 275.

The processor 212 may include one or more processing units or devices including, but not limited to, digital signal processors, microcomputers, microcontrollers, field programmable gate arrays (FPGAs), application specific integrated circuits (ASICs), programmable logic devices (PLDs) and programmable logic arrays (PLAs), memories, analog circuits, digital circuits, software, and firmware. The hardware and firmware components of the processor 212 may include various specialized units, circuits, software and interfaces for providing the functionality and features described here. The processes, functionality and features may be embodied in whole or in part in software which operates with or within the processor 212.

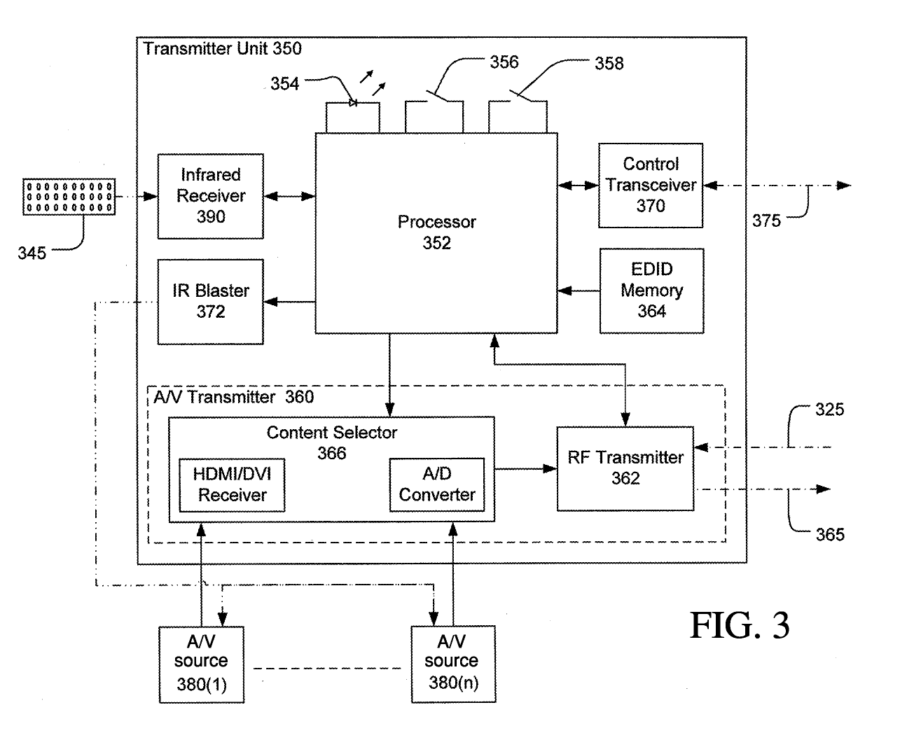

FIG. 3 is a block diagram of a transmitter unit 350, which may be the transmitter unit 150 of FIG. 1. The transmitter unit 350 may include an A/V transmitter 360, a second control transceiver 370, and a processor 352. The transmitter unit 350 may include or be coupled to a second remote input interface 390, which may be an infrared receiver.

The A/V transmitter 360 may include an RF transmitter 362, and a content selector 366. The content selector 366 may select A/V content from one of the A/V content sources 380(1)-380(n) and provide the selected content to the A/V transmitter 362. The content selector 366 may convert the content into a format required for transmission by the RF transmitter 362 as the wireless A/V signal 365. The content selector 366 may accept A/V content from the A/V content sources 380(1)-380(n) in one or more formats that may include, for example, HDMI, DVI, SCART, composite video, S-video, component video, component audio, TOSLINK, and ADAT Lightpipe. The content selector 366 may accept audio/video content in more than one format. If the content selector 366 is adapted to accept audio/video content in more than one format, the content selector 366 and/or the processor 352 may convert the multiple accepted formats into a common format prior to transmission by RF transmitter 362. In addition, the transmitter unit 350 may receive video transmission control data from a receiver unit via a wireless backchannel signal 325.

The content selector 366 may include an HDMI receiver to accept HMDI signals from one or more of the A/V content sources 380(1)-380(n). The content selector 366 may include at least one analog to digital (A/D) converter to accept analog A/V signals from one or more of the A/V content sources 380(1)-380(n). The content selector may include separate A/D converters to separately convert analog video and audio signals to digital signals.

The A/V transmitter 360 may decrypt audio/video content received from one of the content source 380(1)-380(n) using the HDCP protocol and an encryption key negotiated with the content source. The A/V transmitter 360 may re-encrypt the content transmitted over the wireless A/V signal 365 using an encryption key and method defined for communication between the transmitter unit 350 and a mating receiver unit.

The processor 352 may supervise and coordinate the operation of the A/V transmitter 360, the control transceiver 370, and the remote input interface 390. The processor 352 may perform processing operations including, but not limited to, translating data formats between the other elements of the transmitter unit 350 and performing calculations that may be required to exchange key selection vectors and establish an encrypted communication path with one or more of the A/V content sources 380(1)-380(n) according the HDCP protocol. The processor 352 may be coupled to a mate switch 358 that causes the processor to initiate a mating application to negotiate and establish parameters required for the processor unit 350 to exclusively communicate with a designated receiver unit (not shown in FIG. 3), such as, for example, receiver unit 110 (FIG. 1) or 210 (FIG. 2). The parameters may include one or more frequencies, data rates, encryption keys, configuration parameters, and other parameters required to “mate” the transmitter unit 350 to a unique receiver unit.

The processor 352 may be coupled to an EDID memory 364 holding Enhanced Display Identification Data, which may be provided to one or more of the A/V content sources 380(1)-380(n) when required.

The processor 352 may be coupled to one or more channel switches 356 that cause the content selector 366 to select A/V content from one of the A/V content sources 380(1)-380(n). For example, the channel switch 356 may be a single switch that, when actuated by a operator, causes the content selector 366 to cyclically select A/V content from a different source. The processor 352 may be coupled to one or more indicators 354 that indicate the selected one of the A/V content sources 380(1)-380(n). For example, the indicators 354 may include a multicolored light emitting diode corresponding to each input port on the content selector 366, with a first color displayed if an A/V source is connected to the corresponding port but not selected and a second color displayed if the A/V source connected to the corresponding port is selected.

The processor 352 and content selector 366 may include one or more processing units or devices including, but not limited to digital signal processors, microcomputers, microcontrollers, field programmable gate arrays (FPGAs), application specific integrated circuits (ASICs), programmable logic devices (PLDs) and programmable logic arrays (PLAs), memories, analog circuits, digital circuits, software, and firmware. The hardware and firmware components of the processor 352 and content selector 366 may include various specialized units, circuits, software and interfaces for providing the functionality and features described herein. The processes, functionality and features may be embodied in whole or in part in software which operates with or within the processor 352.

The second control transceiver 370 may communicate control information with a remote receiver unit over the RF command channel 375. The control information received by the second control transceiver 370 may include commands that control, at least in part, the operation of the transmitter unit 350. For example, the control information received by the second control transceiver 370 may include commands that turn the transmitter unit 350 ON or OFF, and/or commands that cause the content selector 366 to select audio/video content from one or more of the A/V content sources 380(1)-380(n).

The control information received by the second control transceiver 370 may include commands to control, at least in part, at least some of the A/V content sources 380(1)-380(n). The transmitter unit 350 may include, or may be connected to, an IR blaster unit 372. The IR blaster unit 372 may be a second dongle including an IR light emitting diode or other IR emitter connected to the transmitter unit 350 by a short cable. The cable may be adapted to allow the IR blaster unit 372 to be positioned to transmit IR commands to the A/V content sources 380(1)-380(n). The IR blaster unit 372 may relay or repeat commands received by the second control transceiver 370 to the A/V content sources 380(1)-380(n). The commands relayed by the IR blaster unit 372 may be in place of, or in addition to, commands transmitted to the A/V content sources using dedicated remote control devices. The transmitter unit may also receive commands directly from a remote input unit, such as remote input 345, through an internal or attached remote input interface, such as infrared receiver 390.

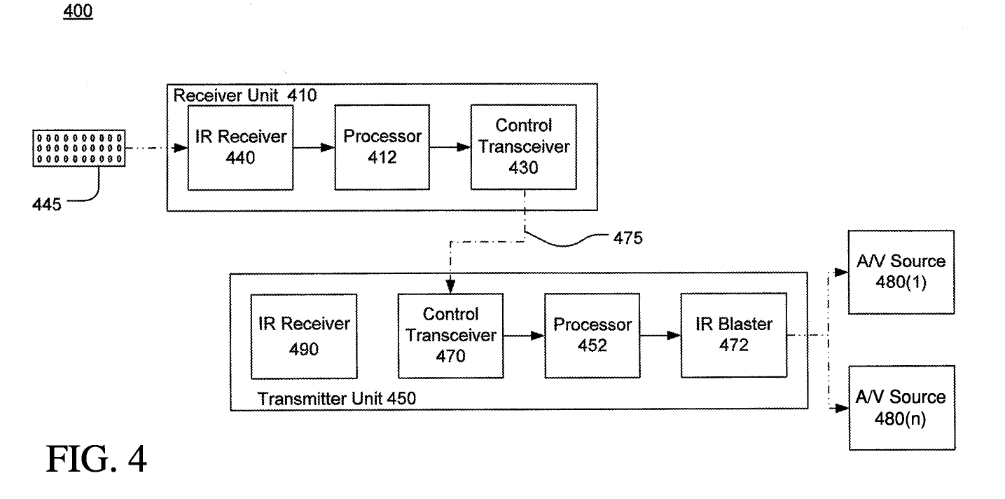

Referring now to FIG. 4, a system 400 for wireless transmission and control of audio/video content may include a receiver unit 410, a transmitter unit 450, and a remote input device 445. The system 400 may be disposed such that a line of sight does not exist between the transmitter unit 450 and the operator of the remote input device 445. In this case, the system 400 may be configured such that commands entered by an operator using the remote input device 445 may be communicated to the transmitter unit 450 and the A/V content sources 480(1)-480(n) via a radio frequency command channel 475.

Input data entered using the remote input device 445 may be received by a remote input IR receiver 440 integral to the receiver unit 410. In other examples, the remote input IR receiver 440 is separate from receiver unit 410. At least some of the input data received by the remote input IR receiver 440 may be commands to be interpreted by the processor 412 and executed within the receiver unit 410. For example, input data that could be entered using the remote input device 445 may include a command to turn the receiver unit 410 on or off.

Input data entered using the remote input device 445 and received by the IR receiver 440 may be processed and reformatted by the processor 412 as required for compatibility with a control transceiver 430. The reformatted input data may then be transmitted via the command channel 475 from the receiver unit control transceiver 430 to the transmitter unit control transceiver 470. Upon receipt at the transmitter unit, the input data may be processed and reformatted by a processor 452. The processor 452 may, for example, return the input data to its original format as received by the IR receiver 440.

At least some of the control information received by the transmitter unit control transceiver 470 may be commands to be interpreted and executed within the transmitter unit 450. For example, the input data that may be entered using the remote input device 445 may include a command to turn the transmitter unit 450 ON or OFF, and commands to select audio/video content from one or more of the A/V content sources 480(1)-480(n).

Input data entered using the remote input device 445, received by the remote control IR receiver 440, and transmitted from the receiver unit control transceiver 430 to the transmitter unit control transceiver 470 may then be relayed to at least some of the A/V content sources 480(1)-480(n) through IR blaster 472. The IR signal emitted from IR blaster 472 may effectively replicate the IR signal emitted from the remote input device 445. Thus a remote input device 445 trained to directly control at least some of the A/V content sources 480(1)-480(n) may be used to control the same content sources remotely, using the wireless path between the receiver unit 410 and the transmitter unit 450 to essentially extend the range of the remote input device 445.

Note that the transmitter unit 450 may include a second IR receiver 490, which may be unusable if the transmitter unit 450 is not within a line of sight from the remote input device 445. Either or both of the receiver unit IR receiver 440 and the transmitter unit IR receiver 490 may be internal to the respective unit. Either or both of the receiver unit IR receiver 440 and the transmitter unit IR receiver 490 may be in the form of a dongle external to the respective unit and coupled to the respective unit by a short cable that allows positioning the IR receiver conveniently. The receiver unit IR receiver 440 and the transmitter unit IR receiver 490 may be a single dongle that is selectively coupled to either the transmitter unit 450 or the receiver unit 410 during system configuration. The receiver unit IR receiver 440 may be external to, and disconnectable from, the receiver unit 410 and the transmitter unit IR receiver 490 may be internal to the transmitter unit 450, but may be automatically disabled if the receiver unit IR receiver 440 is connected.

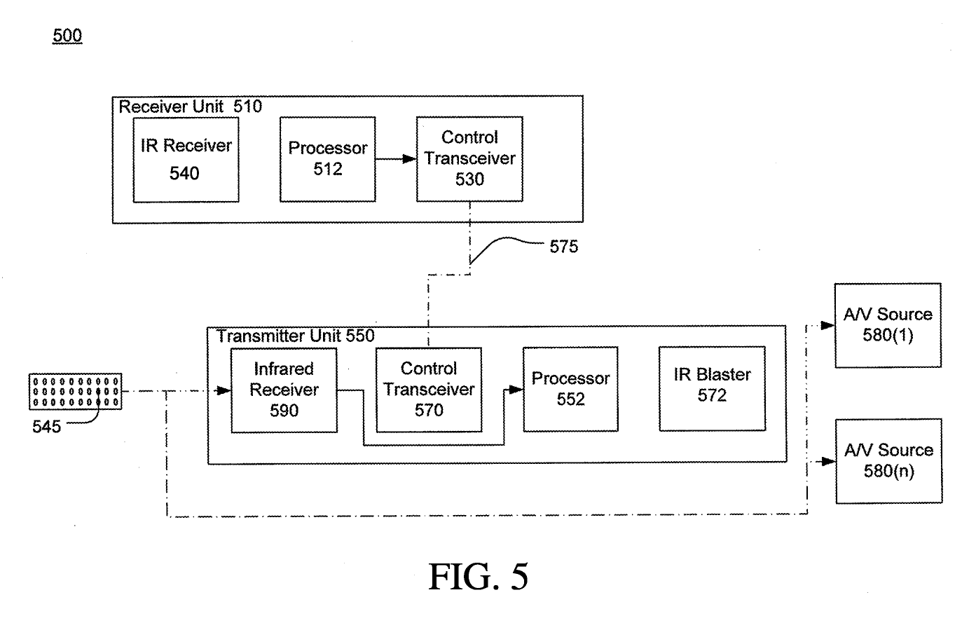

Referring now to FIG. 5, a system 500 for wireless transmission and control of audio/video content may include a receiver unit 510, a transmitter unit 550, and a remote input device 545. The system 500 may be disposed such that a line of sight does exist between the transmitter unit 550 and the operator of the remote input device 545. In this case, the system 500 may be configured such that commands entered with the remote input device 545 may be communicated directly to the transmitter unit 550 and the A/V content sources 580(1)-580(n) directly. For example, the IR receiver 590 can receive a command from the remote input device 545. The data received by the IR receiver 590 can be passed to and processed by the processor 552. In this case an IR receiver 540 within or coupled to the receiver unit may not be used, or may not be present, and a control path 575 between the receiver unit 510 and the transmitter unit 550 may exist, but may not be used to communication remote control input data. In other examples, the IR Receiver 540 may be connected and used to receive commands solely for the receiving unit 510. In the same or other examples, the command path 575 is used to provide commands to the receiving unit 510 that are receiving from the remote input device 545 via the IR receiver 590. As an example, a control transceiver 570 of the transmitter unit 550 can pass the commands to a control transceiver 530 of the receiver unit 510. The commands received by the control transceiver 530 can pass to and be processed by a processor 512.

In addition, in the example of FIG. 5, the remote input device 545 has line of site with the A/V content sources 580(1)-580(n). Therefore, the A/V content sources 580(1)-580(n) can receive commands from the remote input device 545 or other remote control devices that may be dedicated to the individual A/V content source of A/V content sources 580(1) 580(n). In other examples, the remote input device 545 may have a line of site with the transmitter unit 550 but not the A/V content sources 580(1)-580(n). In such an example, the transmitter unit 550 may also include an IR blaster 572 that can relay the commands from the remote input device 545 to the A/V content sources 580(1)-580(n).

Additional and fewer units, modules or other arrangement of software, hardware and data structures may be used to achieve the processes and apparatuses described herein.

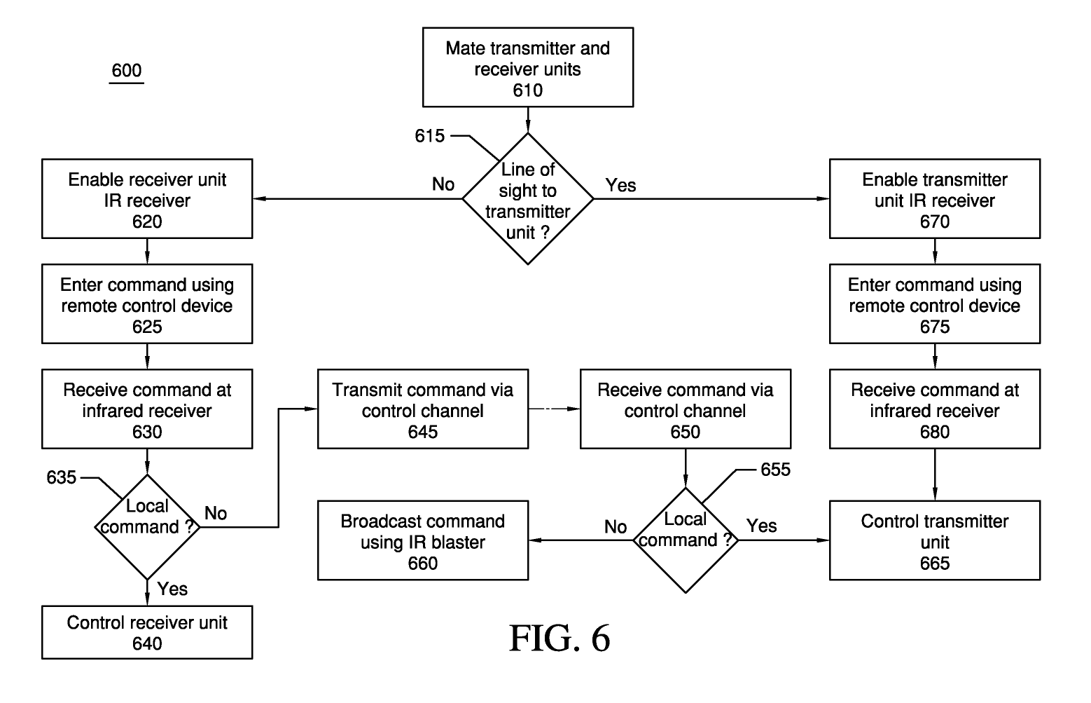

FIG. 6 shows a flow chart of a process 600 for controlling a system for wireless transmission of audio/video content, wherein the system for wireless transmission of audio/video content includes a transmitter unit to transmit audio/video content to a remote receiver unit. The process 600 may be compatible with the systems for wireless transmission of audio/video content 100 (FIG. 1), 400 (FIG. 4), and/or 500 (FIG. 5); the receiver units 110 (FIG. 1), 210 (FIG. 2), 410 (FIG. 4) and/or 510 (FIG. 5); the transmitter units 150 (FIG. 1), 350 (FIG. 3), 450 (FIG. 4), and/or 550 (FIG. 5); and other units and systems.

The process 600 begins at 610 when a transmitter unit and a receiver unit are mated. A mated transmitter unit and receiver unit may be able to communicate A/V content and other information exclusively with each other. A transmitter unit and a receiver unit may be mated by establishing or negotiating necessary parameters which may include one or more of a frequency, a data rate, a bandwidth, a code, an encryption key, and other parameters. A transmitter unit and a receiver unit may be mated during manufacture. A transmitter unit and a receiver unit may be mated using mating applications running on processors within each unit as described in conjunction with the examples of FIG. 2 and FIG. 3.

During deployment or installation of a system for wireless transmission of audio/video content, the receiver unit may be disposed with a display device which will be within sight of an operator/viewer. The transmitter unit may be disposed within, or not within, the line of sight of the operator.

At 615, a decision may be made if the transmitter unit will be disposed such that a line of sight does or does not exist between the transmitter unit and the operator. If a line of sight does not exist between the transmitter unit and the operator, an IR receiver within or attached to the receiver unit, such as for example, IR receivers 140 (FIG. 1), 240 (FIG. 2), 440 (FIG. 4), and 540 (FIG. 5), may be enabled at 620. The IR receiver attached at 620 may be adapted to receive commands from an IR remote input device, such as, for example, IR remote input devices 145 (FIG. 1), 245 (FIG. 2), 345 (FIG. 3), 445 (FIG. 4), and 545 (FIG. 5) used by the operator. The IR receiver may be enabled by, for example, attaching an IR receiver dongle to the receiver unit. If an IR receiver within or attached to the receiver unit is enabled at 620, an IR receiver unit within or attached to the transmitter unit may then be disabled. The IR receiver within or attached to the transmitter unit may be disabled manually, or may be disabled automatically when the IR receiver is attached to the receiver unit at 620.

At 625, the operator may enter input data using the remote input device. At 630, the input data may be received at a receiver unit. At 635, a determination may be made if the received input data is a command to be executed locally within the receiver unit. If the input data is a local command, the command may be executed to control the receiver unit at 640. For example, the input data entered at 625 may be a command to turn the receiver unit ON or OFF.

If the input data is not a command for execution with the receiver unit, the input data may be transmitted over a command channel, such as command channels 175 (FIG. 1), 275 (FIG. 2), 375 (FIG. 3), 475 (FIG. 4), and 575 (FIG. 5), to the transmitter unit at 645. Note that, for expedience, all input data, including commands for execution within the receiver unit, may be transmitted at 645. At 650, the input data transmitted over the command channel may be received by the transmitter unit. The input data can be used to control the transmitter unit to select audio/video content from one of a plurality of audio/video content sources.

At 655, a determination may be made if the input data received at the transmitter unit is a command to be executed locally within the transmitter unit. If the input data is a local command, the command may be executed to control the transmitter unit at 665. For example, the input data entered at 625 may be a command to turn the transmitter unit ON or OFF, or may be a command to cause the transmitter unit to select audio/video content from a designated one of a plurality of content sources.

If the input data received at the transmitter unit is not a command for execution with the transmitter unit, the input data may be broadcast at 660 using an IR blaster as previously described. Note that, for expedience, all input data, including commands for execution within the receiver or transmitter units, may be broadcast at 660.

If, at 615, a decision is made that the transmitter unit will be disposed such that a line of sight does exist between the transmitter unit and the operator, an IR receiver, such as, for example, IR receivers 190 (FIG. 1), 390 (FIG. 3), 490 (FIG. 4), and 590 (FIG. 5), within or attached to the transmitter unit may be enabled at 670. The IR receiver enabled at 670 may be adapted to receive commands from the IR remote input device used by the operator. The IR receiver may be enabled by, for example, attaching an IR receiver dongle to the transmitter unit. If an IR receiver within or attached to the transmitter unit is enabled at 670, an IR receiver unit within or attached to the receiver unit may then be disabled. The IR receiver within or attached to the receiver unit may be disabled manually, or may be disabled automatically when the IR receiver is attached to the transmitter unit at 620. Note that a single IR receiver dongle may be selectively attached to either the transmitter unit or the receiver unit.

At 675, the operator may enter input data using the remote input device. At 680, the input data may be received at the transmitter unit. The input data may be interpreted and may be executed by the transmitter unit at 665. For example, the input data entered at 675 may be a command to turn the transmitter unit ON or OFF. At least some of the input data from the transmitter unit can be relayed to at least one audio/video content source using an IR blaster.

In other embodiments, the receiver unit can send video transmission control information to the transmitter unit via a backchannel independent of the wireless command channel, and the transmitter unit can send video transmission control information to the receiver unit embedded within the audio/video content. The video transmission control information can include Enhanced Display Identification Data (EDID) information. The transmitter unit can provide EDID information to at least one audio/video content source. The transmitter also can provide EDID information from a display device connected to the receiver unit when EDID information from the display device is available, and the transmitter unit further can provide EDID information from an internal EDID memory if EDID formation from a display device connected to the receiver unit is not available.

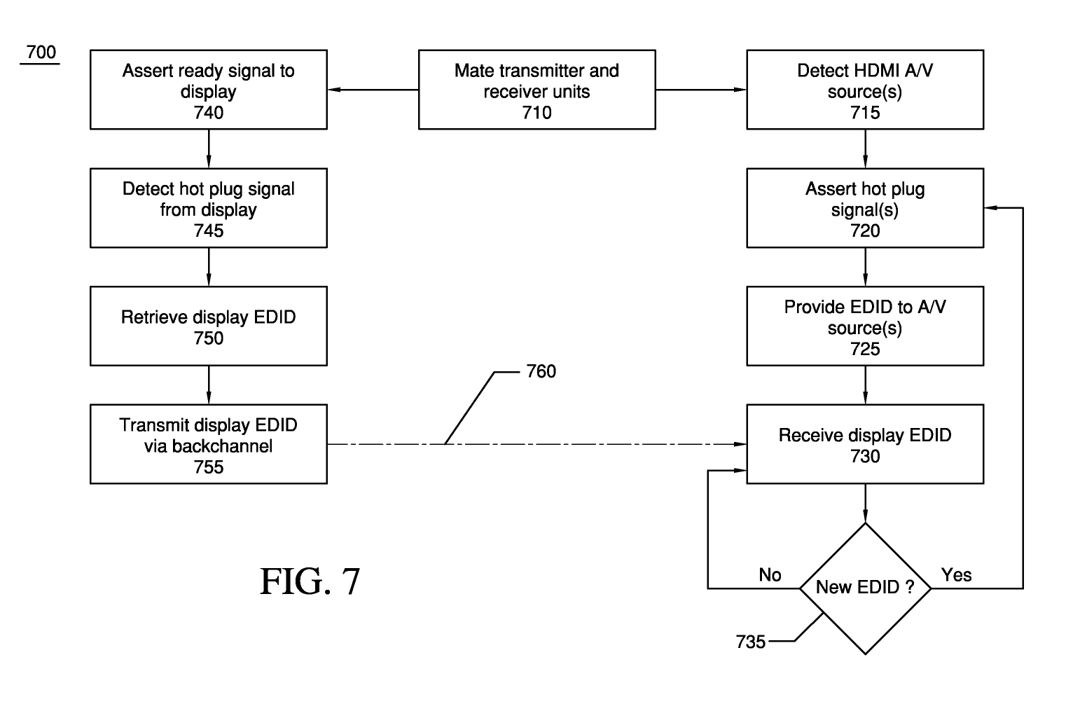

FIG. 7 shows a flow chart of a process 700 for exchanging Enhanced Display Identification Data between a system for wireless transmission of audio/video content, a display device, and one or more A/V content sources. The system for wireless transmission of audio/video content may be the systems 100 (FIG. 1), 400 (FIG. 4), and/or 500 (FIG. 5) and may include a receiver unit and a transmitter unit, which may be the receiver units 110 (FIG. 1), 210 (FIG. 2), 410 (FIG. 4) and/or 510 (FIG. 5) and the transmitter units 150 (FIG. 1), 350 (FIG. 3), 450 (FIG. 4) and/or 550 (FIG. 5), respectively. The receiver unit may be connected to a display device through an HDMI interface, and the transmitter unit may have a plurality of ports that may be connected to one or more A/V content sources.

The transmitter unit and receiver unit may be mated at 710 as previously described. At 715 the transmitter unit may detect the presence of any HDMI A/V content sources that may be connected to ports of the transmitter unit. The HDMI A/V content sources may be detected by the presence of a 5-volt potential or ready signal on a designated pin of the HDMI interface. Upon detection of a ready signal on an HDMI interface at 715, the transmitter unit may assert a hot plug signal to indicate its presence to the connected A/V source at 720. The connected A/V content source may then request, and the transmitter unit may provide, EDID information at 725. In the event that EDID information from the display device is not available, the transmitter unit may provide EDID information from an internal EDID memory.

At 740, the receiver unit may assert a 5-volt ready signal to indicate its availability to the display device. At 745, the display device may respond with a hot plug signal which is detected by the receiver unit. At 750, the receiver unit may request, and the display device may provide, EDID information. At 755, the display device EDID information may be transmitted by the receiver unit. The EDID information may be edited or reformatted as required for compatibility with the capabilities of the communication link 760 between the receiver unit and the transmitter unit. At 730, the display device EDID information may be received at the transmitter unit and reconstructed as necessary. The communication link 760 over which EDID information may be sent from the receiver unit to the transmitter unit may be a backchannel or a command channel or some other wireless communication method.

At 735, the transmitter unit may recognize the existence of new EDID information and initiate the transfer of this information to one or more HDMI compatible A/V content sources (720/725).

Furthermore, process 700 can include additional elements not shown in FIG. 7. For example, after the EDID has been provided to A/V source, the transmitter unit can receive an A/V signal from the A/V source. Then the transmitter unit can send a second A/V signal, which contains the data in the first A/V signal, to the receiver unit. Next, the receiver unit can send a third A/V signal, which can include the data from the first and second A/V signal, to the display device. Finally, the display device can display the video components of the A/V signals and/or output the audio from the A/V signals.

In some examples, such as, when a line-of-sight does not exist between the transmitter unit and a user, an infrared receiver dongle to receive the input data can be coupled to the receiver unit; the receiver unit can send data to the transmitter unit indicating that the infrared receiver dongle is coupled to the receiver; and an infrared receiver within the transmitter unit can be not enabled. In other examples, such as, when a line-of-sight does exist between the transmitter unit and the user, the infrared receiver dongle to receive the input data can be not coupled to the receiver unit; the receiver unit can send data to the transmitter unit indicating that the infrared receiver dongle is not coupled to the receiver; and an infrared receiver within the transmitter unit can be enabled.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more.

As used herein, a “set” of items may include one or more of such items.

As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims.

As used herein, “and/or” means that the listed items are alternatives, but the alternatives also include any combination of the listed items.

Although aspects of the subject matter described herein have been described with reference to specific embodiments, it will be understood by those skilled in the art that various changes may be made without departing from the scope of the subject matter described herein. Accordingly, the disclosure of embodiments is intended to be illustrative of the scope of the subject matter described herein and is not intended to be limiting. It is intended that the scope of the subject matter described herein shall be limited only to the extent required by the appended claims. To one of ordinary skill in the art, it will be readily apparent that the devices and method discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the subject matter described herein and claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A wireless transmission system, comprising:
a receiver unit capable of being coupled to a display device; and
a transmitter unit that sends a wireless signal to the receiver unit;
wherein:
the wireless signal comprises a bandwidth sufficient enough to carry high definition video content.

2. The system of claim 1, wherein:
the receiver unit comprises:
a first processor; and
a receiver; and
the transmitter unit comprises:
a second processor; and
a transmitter.

3. The system of claim 2, wherein:
the receiver unit further comprises a first transceiver; and
the transmitter unit further comprises a second transceiver.

4. The system of claim 3, wherein:
the first transceiver and the second transceiver communicate with each other.

5. The system of claim 2, wherein:
the receiver comprises:
a radio frequency receiver; and
an HDMI transmitter;
wherein:
the radio frequency receiver receives the wireless signal; and
the HDMI transmitter is capable of being coupled to the display device.

6. The system of claim 5, wherein:
the receiver unit further comprises an infrared receiver.

7. The system of claim 2, wherein:
the transmitter comprises:
a content selector; and
a radio frequency transmitter;
wherein:
the radio frequency transmitter transmits the wireless signal;
the content selector comprises an HDMI receiver; and
the content selector is capable of being coupled to one or more content sources.

8. The system of claim 7, wherein:
the transmitter unit further comprises an infrared receiver.

9. The system of claim 8, wherein:
the transmitter unit further comprises an infrared blaster.

10. A wireless transmission system, comprising:
a transmitting portion receiving a first audio/video signal from one or more audio/video sources; and
a receiving portion receiving a second audio/video signal from the transmitting portion and sending a third audio/video signal to a display device;
wherein:
the second audio/video signal is wireless; and
the first audio/video signal, the second audio/video signal, and the third audio/video signal comprise high definition video content.

11. The system of claim 10, wherein:
the second audio/video signal comprises a microwave signal.

12. The system of claim 11, wherein:
the second audio/video signal comprises a 5 gigahertz signal.

13. The system of claim 10, wherein:
the first audio/video signal comprises a first high definition multimedia interface signal.

14. The system of claim 10, wherein:
the third audio/video signal comprises a second high definition multimedia interface signal.

15. The system of claim 10, wherein:
the receiving portion and the transmitting portion communicate via a command signal.

16. The system of claim 15, wherein:
the receiving portion comprises:
a first infrared receiver;
a first processor; and
a first control transceiver; and
the receiving portion is capable of sending the command signal via the first control transceiver.

17. The system of claim 10, wherein:
the transmitting portion comprises:
a second infrared receiver;
a second processor; and
a second control transceiver.

18. The system of claim 10, wherein:
the transmitting portion comprises a content selector, and
the content selector is capable of selecting one of the one or more audio/video sources to provide the first audio/video signal.

19. A process for exchanging data, comprising:
detecting the presence of one or more audio/video sources that are coupled to a transmitter unit;
indicating the presence of the transmitter unit to the one or more audio/video sources;
indicating the presence of a receiver unit to a display device;
detecting a signal from the display device by the receiver unit;
retrieving enhanced display identification data from the display device;
transmitting the enhanced display identification data from the receiver unit to the transmitter unit; and
providing the enhanced display identification data from the transmitter unit to the one or more audio/video sources.

20. The process of claim 19, further comprising:
storing the enhanced display identification data in a memory.

21. The process of claim 19, further comprising:
mating the transmitter unit and the receiver unit.

22. The process of claim 19, further comprises:
transmitting a wireless audio/video signal from the transmitter unit to the receiver unit, wherein the wireless audio/video signal comprises high definition content.
